(19) United States
(12) Patent Application Publication
(10) Pub. No.: US 2008/0296901 A1
(43) Pub. Date: Dec. 4, 2008

(54) HOODED MARINE FLOAT WIND POWER GENERATOR STRUCTURE

(76) Inventor: Kuo-Shen LIU, Taipei (TW)

Correspondence Address: LEONG C LEI, PMB # 1008, 1867 YGNACIO VALLEY ROAD, WALNUT CREEK, CA, 94598, US

(21) Appl. No.: 11/754,372

(22) Filed: May 29, 2007

(51) Int. Cl. F03D 9/00

(52) U.S. Cl. 290/55

(57) ABSTRACT

A hooded marine float wind power generation system includes a float platform set on a sea surface, a steel cable connecting the float platform and fixed to a sea bottom anchor to prevent undesired shining of the float platform. The float platform is provided with a wind power generator that is completely fixed on the float platform. A hood surrounds the generator to also function as a tail wing so as to make the float platform and the generator to change direction in response to wind direction and thus directly opposing to the wind to extract the most wind power and realize the best power generation performance. Due to the floating configuration of the float platform, the hood will not be tipped or damaged by side winds. Windmill blades can be made small is size and costs are thus reduced.

### BACKGROUND OF THE INVENTION

(a) Technical Field of the Invention

The present invention relates to a hooded marine float wind power generator stricture, and In particular to a murine wind power generator structure featuring low costs and excellent performance of power generation.

(b) Description of the Prior Art

Power generation based on wind energy has been put in operation for years and a variety of horizontal-axis power generators have been developed. However, all types of wind power generators share some common problems:

(1) Blades and generator must be fixed on the ground by a lower, but (they must also be direction changeable with the direction of wind flow in order to exactly lace the wind flow: Titus, they cannot be completely fixed with, respect to the tower and is often mounted to the tower with bearing. This makes the construction of the tower very difficult and expensive.

(2) The tower has to bear the from wind and side winds, as well as lilting force induced by the blades when blades are acted upon by the winds and the weight of the power generator. Thus, when the wind is of a great speed, the tower may tail to bear the wind force. Consequently the wind power generation system has to be shut down when wind speed exceeds 25 m/sec.

(3) The centrifugal force acting on foe windmill blade is large for large-sized wind power generation system and thus, the wind power generation system must has a strong mechanical structure, which is often associated with high expense.

(4) Additional loads, such as lead/lag of the rotation of the windmill blades, flapping, pitching and wind shearing, wind gusts, wind shifts, gravity and tower shadow; may cause periodic shock and resonance, which influences the service lives of the blades, bearing, aid tower.

(5) The reunion of the windmill blades causes great noise, which makes residence very tough.

(6) Birds may be damaged and killed.

(7) Radio communication may be interfered with.

(8) A large area is occupied, leading to high costs of land acquirement Marine wind power generation may solve the problem associated with land acquirement and possesses an advantage mat the air how or wind is more stable in the sea than in the land. However, construction of windmill tower on sea is difficult and the base of the tower may be corroded by the sea water. Thus, although marine wind power generation has an output power that is 50% higher man a counterpart land based wind power generation system, the cost of she marine wind power generation is 60% higher than that of the land-based wind power generation. Therefore, economically, the marine wind power generation is less efficient than the land-based wind power generation.

U.S. Pat. No. 4,775,340 discloses a wind power generator that floats on the sea surface. However, a tower is needed and although the tower does not need to carry the weight of the generator, yet it needs to take the front and side winds and a rotation bearing is required to set: at the center thereon. Also, a tail wing is needed. Apparently, the wind power generator does not differ horn other known marine power generation systems. A different construction disclosed in the said patent: comprises a propeller arranged below a platform of the generation system for adjusting die direction of die platform. This consumes power and cannot efficiently change the direction of the platform in immediate response to the wind shift.

U.S. Pat. No. 7,075,189 discloses a wind power generator that floats on the sea surface. However, a tower is still needed Further, to provide a function similar to change direction by means of tails, a plurality of small-sized generators is used to replace a single, large-sized generator and two of foe small-sized generators are used to adjust wind direction. Such a complicated sanctum certainly increases the costs, making it not mom economically efficient titan the land-based wind power generation systems.

These prior an: references clearly show that a ilea; on sea surface still need to adjust with respect to wind direction and if the platform and tower does not change direction in response to the change of wind direction, then bearing is still needed for the tower. This makes the marine wind power generation system just the same as a land-based wind power generation system. The construction of the tower would be difficult.

In case the platform and the tower are allowed to change direction by following the wind direction, then the tower car; be an immobile structure and the construction of the tower is simplified. However, to change foe direction of the platform, which is usually bulky a huge tail wing is needed; otherwise the teachings suggested in the previously mentioned patents must be adopted, making the marine wind power generation system very impractical. This concludes foe mason why no commercial operation of a marine boat wind, power generator is available in the market.

On the other hand, adding a flood certainly facilitates increasing wind speed. Due to the tact that the wind speed is the output power raised to hie third power, the size of the blades ears be reduced to provide exactly the same output. However, adding a hood means an increase of the footprint of the wind power generation system, also increasing the wind three acting on the system and being more difficult to build the tower, the hood being bulky in size, and making it difficult for the system to change direction in response so wind direction.

Conclusively the currently existing wind power generation system still suffers a variety of drawbacks and is not economically comparable to the traditional power generation techniques. However, in all type of reusable resources, wind power generation is of the moss economic value and it is the primary challenge to the reusable resources development to further improve the wind power generation.

### SUMMARY OF THE INVENTION

The primary purpose of the present invention is to provide a hooded marine float wind power generator, which reduces the costs of marine wind power generation and provides improved power generation performance.

To achieve the above objective, in accordance with the present invention, a hooded marine float wind power generation system is provided, comprising a float platform set on a sea surface, a steel cable connecting the float platform and fixed to a sea bottom anchor to prevent, shilling of the float platform. A wind power generator is mounted on the float platform and a hood is arranged to surround generator to also junction as a tall wing so as to make the float platform and the generator to change direction in response to wind direction and thus directly opposing to the wind to extract the most wind power and realize the best power generation performance. Since the float plat loon and the wind power generator are fixed together, the abstraction is simplified and cart replace the expensive tower to flintier reduce the costs.

In the hooded marine float, wind power generation system, the hood can be constructed as a diffuser or a concentrator or a combination of both.

In the hooded marine float wind power generation system, the hood is comprised of a frame made of metal sunk as steel and a metal skin and further comprises a fishing net covering an inlet opening thereof to prevent invasion of birds.

In the hooded marine float, wind power generation system, the hood is further provided with, wanting lights to prevent being collided by ships at nighttime.

In the hooded marine float wind power generation system, the hood is provided with a metal skirt door, which is automatically opened at the time when a hurricane attacks to prevent: the wind three from exceeding the mechanical strength of all components.

In the hooded marine float wind power generation system, the metal skin door of the hood has a lower edge to which rollers are mounted to move along a track so that in case of excessively stone wind, a wind speed detector and a controller are operated to activate a motor that is related rightward to drive a shaft and a cable to move metal skin, door in a rightward direction so as to retract into a front fixed portion of the metal skin of the hood for releasing excessive wind force. When rite wind tome is reduced back to an appropriate level, the detector and rite controller activate the motor to rotate in a reversed direction to close foe metal skin, door. The motor stops operation when the metal skin door reaches proper location in either the opening process or closing process.

The foregoing object and summary provide only a brief introduction to the present invention. To fully appreciate these and other objects of the present invention as well as the invention itself, ail of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the ant upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 schematically shows the structure of the present invention;

FIG. 2 schematically shows the structure of a hood in accordance with the present invention;

FIG. 3 schematically shows the structure of a metal skirt door in accordance with the present invention:

FIG. 4 schematically shows the structure of a bail-socket loin; in accordance with the present invention;

FIG. 5 schematically shows an embodiment of die present invention consisting two generators:

FIG. 6 schematically shows the structure of a concentrator hood in accordance with a different embodiment of the present invention;

FIG. 7 schematically shows a different embodiment of the hood in accordance with the present inversion; and

FIG. 8 schematically shows a float platform in accordance with a different embodiment of the present invention.

### DETAILED DESCRIPTION OF THE PREFERRED EMBODIMENTS

The following descriptions are of exemplary embodiments only and are not intended to limit the scope, applicability or configuration of the invention in any way. Rather, the following description provides a convenient Illustration for implementing exemplary embodiments of the invention. Various changes to the described embodiments may be made in the function and arrangement of rise elements described without departing from the scope of the invention as set forth in the appended claims.

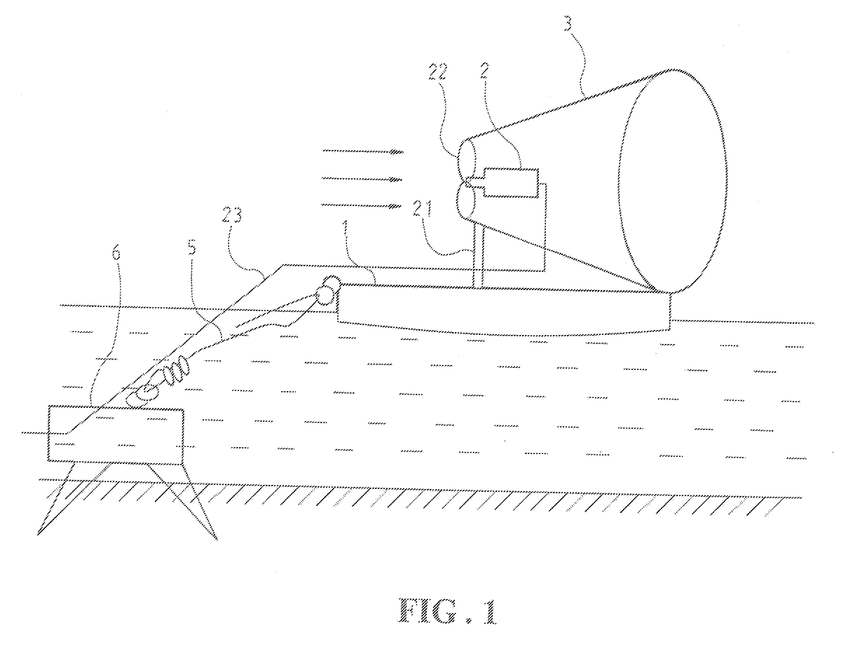

With reference to the drawings, and in particular to FIGS. 1-4, a hooded marine float, wind power generator construction in accordance with tire present invention comprises a float platform 1 on which a support frame 21 is mounted for supporting thereon a generator 2 and a hood 3 serving as a diffuser. The generator 2 is provided with, a windmill, blade set 22 and is electrically connected to a power transmission, line (as well as a power gate control line and a signal line) 23. The float platform 1 is secured to anchor 6, which is fixed on the sea bottom, by a steel cable 5 in such a way to allow the float platform 1 to freely float on the sea surface.

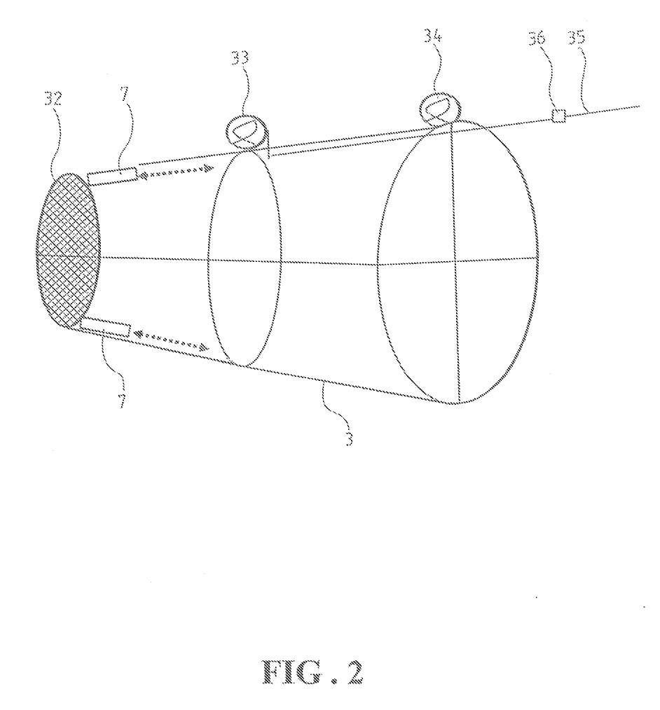

The hood (diffuser) 3 comprises a hollow conic; body forming, a divergent duct: having an Inlet of a small opening and an outlet of a lame opening, which is formed of a frame made of metal such as steel and a metal skin, as shown in FIG. 2. The inlet, opening is covered with a fishing net 32 to prevent birds from entering the hood 31. Additionally mounted to the hood 3 are warning lights 33, 34, which serves to prevent the hood 3 from being accidentally collided by ships at night time. The warning lights 33, 34 are powered through a power cable 35 and are controlled by an automatic nighttime switch 36.

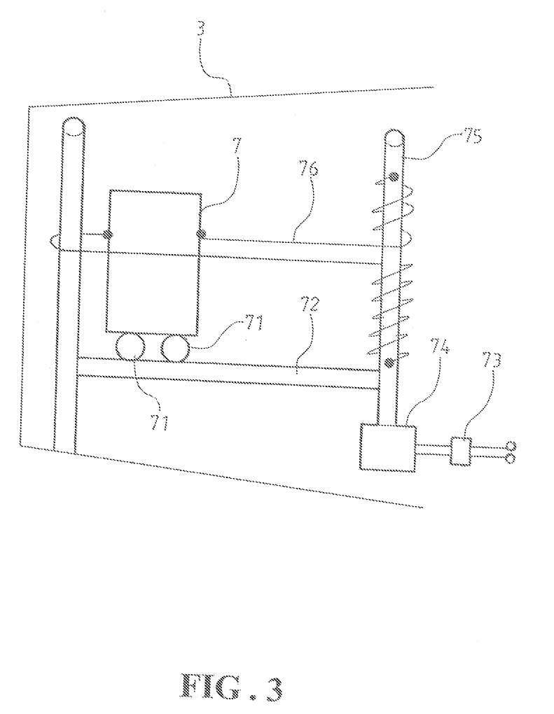

The hood (diffuser) 3, as shown in FIG. 3, is provided with a movable metal skin door 7, which can be automatically open when the hood 3 is attacked by a hurricane, which may have a wind speed exceeding 40 m/sec, to alleviate the load imposed to the mechanical structure thereof. The metal skin door 7 is provided, at a lower edge thereof rollers 71 for traveling along a track 72 so that when the wind, is too strong, a wind speed detector 73 and a controller (not shown) supply power to a motor 74 to activate rotation of the motor 74 in for example a rightward direction for driving a shah 75 and a steel cable 76 to move the metal skin door 7 in the rightward direction to retract back, into a fixed metal skin portion of the front portion of the hood and thus partially releasing the wind three. When the wind force is reduced back: to an appropriate level the detector and the controller activate the motor 74 to rotate in a reversed direction to close the metal skin door 7 the motor 74 stops operation when the metal skin door 7 reaches proper location in either the opening process or closing process.

The float platform 1 is made of substance that is lighter than water and is less expensive, such as polylone, with a steel name added for protection. The float platform 1 has an am utile bottom for reducing drag, of water in drifting on the sea. The anchor 6 is made pre-cast concrete with a bottom thereof forming a fork construction for anchoring to the sea bottom to prevent the platform 1 and the hood (diffuser) 3, as well as the generator 2, from floating away.

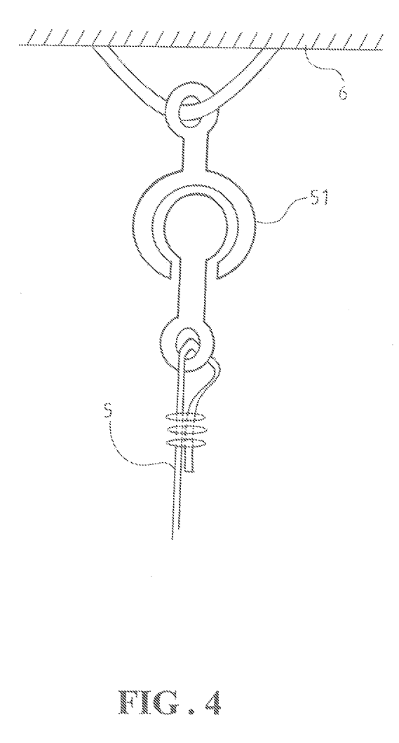

As shown in FIG. 4, foe steel cable 5 and the anchor 6 and the float platform 1 are coupled together by means of metal ring or by a ball-socket joint 51 so that the platform 1 and foe generator 2 can change direction in response to wind direction. Thus rotation bearing is eliminated.

By assembling the above discussed components, a hooded marine float wind power generator structure is thus constructed, which allows the Heat platform 1 and the whole generator 2 to change direction in response to the wind direction for directly opposing the incoming air how and thus retrieving the most power from, the wind and achieving the best power generation performance. Further, the float platform 1 is set in a floating condition, which prevents the hood 3 from tipping over or damage due to side winds.

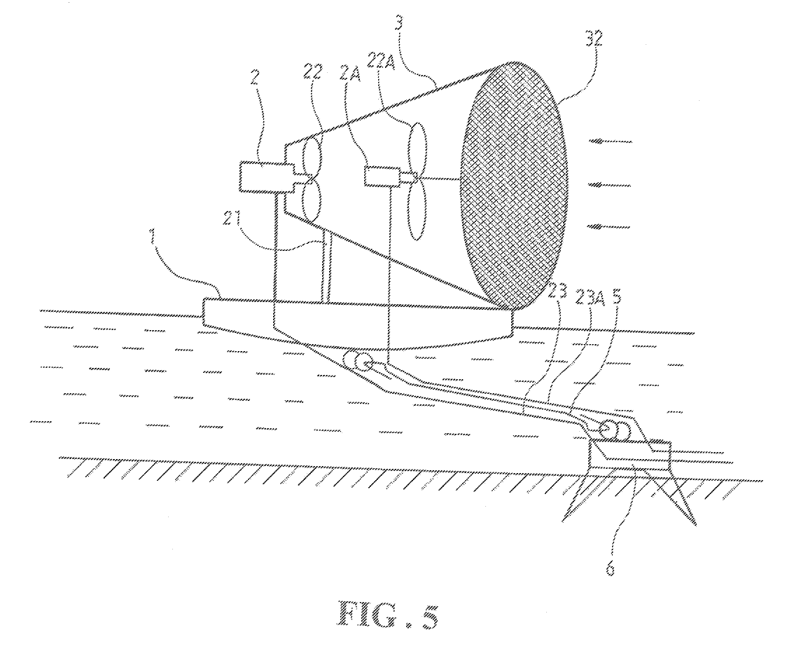

With reference to FIG. 5, the hood 3 can be alternatively made in the form of a concentrator and a secondary power generator 2A on which a secondary blade set 22A is provided to increase the overall efficiency. In this case, the steel cable 5 can be attached to a middle of dm flora platform 1.

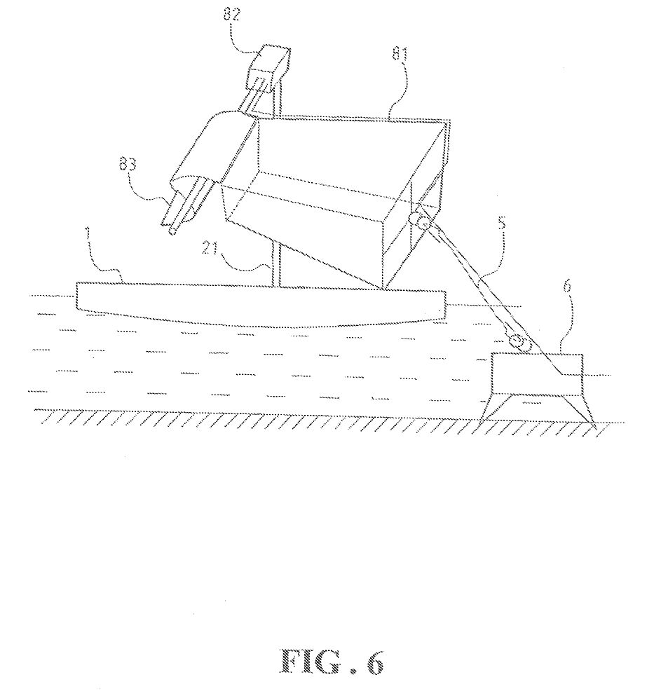

Relenting to FIG. 6, a differently configured hood 3 is presented, comprising a concentrator 81, and a different type power generator 82 is provided. The power generator 82 comprises blades 83 that are Savonius blades. The concentrator 81 is substantially rectangular and half of the blades 83 are substantially located at the outlet opening of the concentrator 81 to take the wind power, while the other half is shielded by the concentrator 81 end thus taking no wind power. This helps enhances the overall efficiency.

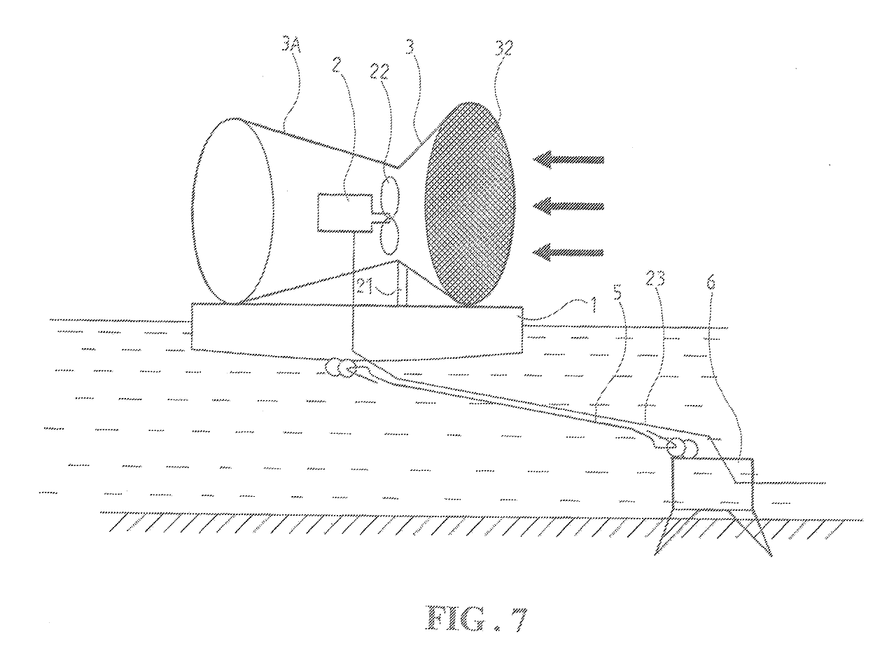

Referring to FIG. 7, in accordance with the present invention, the hood 3 can be comprised of both a concentrator, which is set in the front portion, and a divergent hood 3A (diffuser) can be added and set at die rear portion to further increase the speed of the wind acting upon die blades 22 to thus increase the efficiency.

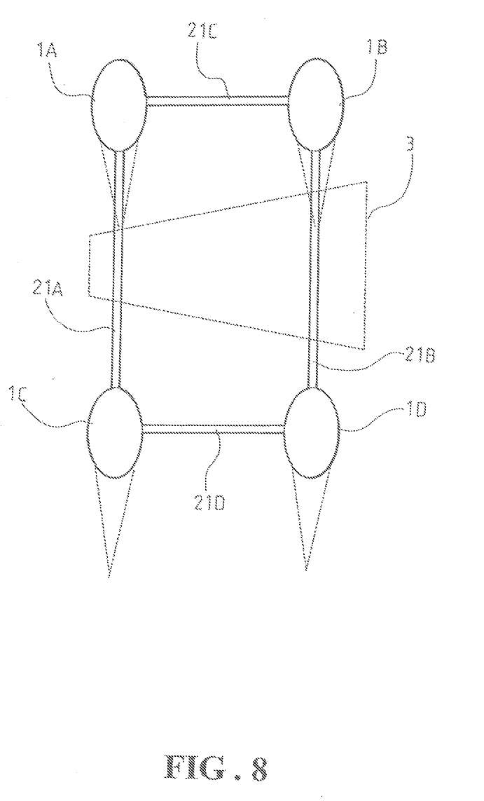

Referring to FIG. 8, in accordance with a different embodiment of the present invention, tire float platform 1 is divided into four segments 1A, 1B, 1C, 1D among which brackets 21A, 21B, 21C, 21D are connected. To reduce foe lifting tome caused by sea tides, the float platform segments 1A, 1B, 1C, 1D can be made as cone having a small projection area and a substantial length. Further, to enhance stability of the float platform 1, the brackets 21A, 21B can be lengthened, to increase the torque that acts against tipping of the hood (concentrator) 3.

As compared to the conventional wind power generators, the present invention possesses at least the following advantages:

(1) Although, the present invention provides a support frame that ads similar to a tower of the conventional wind, power generation system, yet the conventional tower has to take font winds, side winds, lifting force on the blades by the winds, and the weight of the generator and the present invention takes the front winds with the steel cable 5 and the anchor 6 and die side winds in only in effect in moving the float platform 1 sideways, the side winds can be cancelled, by the free sideway movement of the float, platform and thus, the support frame only need, to take minor torque. The lifting force acting on the blades is counteracted by the weights of the float platform 1, the generator 2, and the hood 3, and the steel cable 5 so that the support frame only need to support the weight of foe generator 2, which, as compared to other loads, is much smaller and is a vertical force. Further; the support fume and the generator 2 are fixed with respect to each other so that no bearing is needed. This makes the support frame simple and cheap as compared, to the tower of the conventional wind power generator systems.

(2) Although the present, invention, adds new components, including the hood 3, the float platform 1, and the anchor 6, these components are of low technique level and inexpensive in material costs. Thus, die present invention can use small-sized wind power venerators to replace a single large-sized wind power generator leading to a substantial reduction of costs.

(3) The present invention requires virtually no concrete construction and foe operation of the present invention is not subject to severe influence even if tire anchor 6 is slightly moved by strong winds. Thus, the costs of concrete construction are eliminated.

(4) In the present invention, die platform 1 is floating, providing a function similar to the tail wing of the conventional wind power generator system to allow the direction of the hood 3 to automatically follow hie wind direction, making the hood directly opposing the wind direction. Thus, the tail wing can be eliminated. The concentrator cart serve both as a substitute for large-sized blades and as a large-sized tail wing.

(5) The hood 3 can guide the air flow of die winds and the floating platform 1 can reduce and cushion vibration induced thereon. Thus, die present invention cart effectively reduce damage caused by additional loads.

(6) Contrary to the conventional wind, power generator system, which needs a rotation bearing to couple the tower and the generator; the present invention employs connection, realized by metal raves of simple construction or other measures, such as the ball-socket joint shown in FIG. 4, between the steel cable and the anchor and the hood to readily realize direction change of the frame and generator by following the wind direction. Thus, the rotation bearing is eliminated.

In addition, the present invention combines the advantages of marine wand power generation and those of the hood, but: effectively remove the major drawbacks thereof. Compared to the conventional wind power generator systems, the present invention has the following advantages:

(1) The present invention allows substantial reduction of surface area of the blades and thus reduces the costs.

(2) The present invention does not need a tower fixed on the ground and thus reduces hie costs.

(3) The present invention employs hood, generator, and support frame that are all fixed and have simple mechanical structures and thus foe costs are reduced.

(4) The present invention substantially reduces foe concrete construction and thus reduces the costs.

(5) The present, invention does not need a tail wing and thus reduces the costs.

(6) The present invention uses the sea surface and thus no costs for land are required.

(7) The present invention is installed on the sea surface and no neighbor residents will be interfered with by the noise of the device of the present invention;

(8) The present invention is installed on die sea surface and interference with telecommunication carried out on die land surface is avoided.

(9) The present Invention can be provided with fishing net to prevent hurting birds.

Although, the present invention has been described with reference to the preferred embodiments thereof it is apparent to those skilled in the art that a variety of modifications and changes may be made nit boat departing from the scope of the present invention which is intended to be defined by the appended claims.

It will be understood that each of the elements described above, or two or more together may also find a useful application in other types of method differing from the type described above.

While certain novel features of this invention have been shown and described and are pointed our in the annexed claim, it is not intended to be limited to the details above, since it will be understood that various omissions, modifications, substitutions and changes in hie tonus and details of the device illustrated and in its operation can be made by those skilled in the art without departing in any way from the spirit of the present invention.

I claim:

1. A hooded marine float wind power generation system comprising:
a float platform adapted to set on a sea surface and a sea bottom anchor;
a steel cable connecting the float platform and fixed to die sea bottom anchor;
a wind power generator that is mounted on the float platform and comprises blades; and
a hood surrounding the wind power generator.

2. The hooded marine float wind power generation system as claimed in claim 1, wherein the flood is selectively constructed as a diffuser or a concentrator or a combination of both and selectively has a circular configuration or a rectangular configuration.

3. The hooded marine heat wind power generation system as claimed in claim 1, wherein the blades of the generator are set at an outlet opening of the hood.

4. The hooded marine boat wind power generation system as claimed in claim 1, wherein the generator comprises a turbine, which is selectively a horizontal axis wind power turbine, an impulse type turbine, or a reversed operation turbine.

5. The hooded marine float wind power generation system as claimed in claim 1, wherein generators are respectively set an interior space and an outlet opening, of the hood.

6. The hooded marine float wind power generation system as claimed in claim 1, wherein the float platform is made of polylone or other substance in any desired shape.

7. The hooded marine float wind power generation system as claimed in claim 1, wherein anchor is made of concrete or other substance and is in any desired shape.

8. The hooded marine float wind power generation system as claimed in claim 1, wherein an automatically operable door is provided on the hood, which is selectively and automatically open to release excessive wind force.

9. The hooded marine float wind power generation system as claimed in claim 8, wherein tire automatically operable door comprises a metal skin door having a tower edge to which miners are mounted to move along a track and wherein in case of excessively strong wind, a wind speed detector and a controller are operated to activate a motor that, when put into operation, drives a shaft and a cable to move and thus open/close the metal skin door.
